(19) United States
(12) Patent Application Publication
(10) Pub. No.: US 2006/0292938 A1
(43) Pub. Date: Dec. 28, 2006

(54) High conductivity defroster using a high power treatement

(76) Inventors: Robert Schwenke, Fowlerville, MI (US); Keith D. Weiss, Fenton, MI (US); Rebecca Northey, Portage, MI (US)

Correspondence Address: EXATEC;C/O BRINKS HOFER GILSON & LIONE, P. O. BOX 10395, CHICAGO, IL, 60610, US

(21) Appl. No.: 11/362,490

(22) Filed: Feb. 24, 2006

Related U.S. Application Data
(60) Provisional application No. 60/655,936, filed on Feb. 24, 2005.

(51) Int. Cl. H01R 4/02

(52) U.S. Cl. 439/876

(57) ABSTRACT

The present invention provides for the enhancement of the amount of heat generated in the critical viewing area of a plastic window assembly by lowering the overall resistance of a conductive heater grid and allowing a greater amount of current to pass through the grid lines, thereby, increasing resistance heating of the window. This is achieved by subjecting the heater grid to a high power treatment after forming of the window assembly that reduces the resistance of the conductive heater grid.

### RELATED APPLICATION

This application claims the benefit of U.S. Provisional Application No. 60/655,936, filed Feb. 24, 2005, the entire contents of which are incorporated herein by reference.

### BACKGROUND OF THE INVENTION

Multiple differences exist between the type of conductive materials that are suitable for use in a heater grid designed for a glass panel or window as compared to a heater grid designed for a plastic panel or window. In particular, the manufacturing process for a glass panel or window allows the conductive metallic paste used to form the heater grid to be sintered at a high temperature (>300° C.). The exposure of the metallic paste to a high temperature allows for the metallic particles in the paste to soften and fuse together, thereby resulting in sintered grid lines that exhibit a relatively high level of conductivity or low electrical sheet resistivity of less than or equal to 2.5 milliohms/square @ 25.4 μm (1 mil). In addition, this sintering process can create oxide surface functionality which allows for adequate adhesion of the sintered metallic grid lines to the surface of the glass panel or window.

In comparison, the glass transition temperature (T_{g}) exhibited by most polymer systems is far below a 300° C. process temperature. Thus, a plastic panel or window can not be exposed to the relatively high temperatures found in a glass panel or window manufacturing process. For a plastic panel or window, the conductive metallic pastes can typically only be exposed to a temperature that is lower by about 10° C. or more than the T_{g} exhibited by the plastic panel. For example, polycarbonate has a T_{g} on the order of 140° C. In this case, a cure temperature for the metallic paste should not exceed about 130° C. At this low temperature, the metallic particles do not soften or fuse together. In addition, in order to adhere to the plastic panel or window, a polymeric phase must be present in the conductive paste. This polymeric material will inherently behave as a dielectric between the closely spaced metallic particles. Thus the electrical conductivity exhibited by a cured metallic paste on plastic will typically be lower than that exhibited by a sintered paste on glass.

Due to the lower electrical conductivity exhibited by conductive pastes cured on plastic substrates as compared to sintered metallic pastes printed on high temperature substrates (e.g., glass), heater grid functionality severely suffers when long grid lines are required. There is a need in the industry to enhance and optimize the conductivity exhibited by conductive pastes cured on plastic substrates in order to provide acceptable defrosters for the backlights of large vehicles.

### BRIEF SUMMARY OF THE INVENTION

This invention provides for the enhancement of the amount of heat generated in the critical viewing area of a plastic window assembly by lowering the overall resistance of the conductive heater grid and allowing a greater amount of current to pass through the grid lines, thereby, increasing resistance heating of the window. A plastic window assembly provides defrost & defog capability through the resistive heating of a cured conductive ink and includes a transparent plastic panel; at least one protective layer; a conductive heater grid formed of a printed and cured a conductive ink having more than one primary grid line with opposing ends of each grid line being connected to a first and second busbar; and at least one electrical connection to the first and second busbar thereby establishing a closed electrical circuit is described wherein the formed conductive heater grid has been treated by a high power treatment that reduces the resistance of the conductive heater grid from the resistance of the heater grid absent the high power treatment.

The high power treatment comprises applying a wave shape form to the conductive heater grid having a predetermined amplitude, pulse width, pulse frequency, time duration, and number of applied pulses, wherein the resistance of the conductive heater grid is reduced by greater than about 10%.

Another embodiment of the present invention describes a method for forming a plastic window assembly, the method comprising: printing a conductive ink onto a protective layer of a plastic panel in the form of a heater grid with more than one grid line and at least two busbars; curing the conductive ink of the printed heater grid; establishing electrical connection to each busbar of the heater grid; and subjecting the heater grid to a high power treatment useful for lowering the resistance of the heater grid.

Another embodiment of the present invention describes a second method for forming a plastic window assembly, the method comprising: A method for forming a plastic window assembly, the method comprising: printing a conductive ink onto a plastic protective layer in the form of a heater grid with more than one grid line and at least two busbars; placing the plastic protective layer into the cavity of a mold; injecting a plastic resin into the mold forming a plastic panel; removing the formed plastic panel from the mold; applying protective coating to the plastic panel; establishing electrical connection to each busbar of the heater grid; and subjecting the heater grid to a high power treatment useful for lowering the resistance of the heater grid.

### BRIEF DESCRIPTION OF THE DRAWINGS

FIG. 1 illustrates several examples of voltage waveforms and pulse shapes that can applied to a conductive heater grid as part of a high power treatment according to the principles of the present invention.

FIG. 2 illustrates the definition of various parameters, such as amplitude, pulse width, and # of pulses, in a high power treatment according to the principles of the present invention.

FIG. 3 is an illustration showing the decrease in resistivity observed upon the application of a high power treatment to a conductive heater grid comprising a “cured” highly conductive ink that exhibits an initial sheet resistivity of about 5 milliohms/square @ 25.4 μm (1 mil). The change in sheet resistivity is evaluated as a response to various levels of applied voltage, pulse width, and pulse frequency, which are depicted as the various sides of a cube.

FIG. 4 is a graph of sheet resistivity versus voltage for two different pulse width levels used in a high power treatment according to the principles of present invention. The high power treatment is applied to a conductive heater grid comprising a “cured” conventional conductive ink that exhibits an initial sheet resistivity of about 10 milliohms/square @ 25.4 mm (1 mil).

FIG. 5 provide schematics (A-D) depicting the cross-section of various possible plastic window assemblies.

FIG. 6 is a plan view of a window assembly embodying the principles of the present invention and illustrating a heater grid with a plurality of grid lines extending between two busbars.

### DETAILED DESCRIPTION OF THE INVENTION

This invention relates to a transparent plastic glazing panel that can be defrosted to meet accepted automotive defrosting standards in the form of the SAE J953 (1999) test protocol (Society of Automotive Engineers, Warrendale, Pa.), entitled “Passenger Car Backlight Defogging System”. In order to meet this test standard, the heater grid of the present invention when part of a plastic window assembly is subjected to a high power treatment method to enhance the conductivity exhibited by the printed, conductive ink and to reduce the overall resistance of the formed heater grid.

Conventional conductive pastes or inks are very limited in their capability to function as a defroster for a plastic automotive window. Primarily, the relatively low conductivity exhibited by conventional conductive inks and pastes limits the length of a grid line to about 750 mm (˜30″) in order for the heater grid to function appropriately. Unfortunately, most vehicle rear windows are wider than 750 mm and require a heater grid with grid lines in excess of 750 mm. Examples of conventional conductive inks or pastes along with their associated manufacturer are shown in Table 1. The inventors have determined that the sheet resistivity exhibited by conventional conductive inks or pastes (ink a→ink m) is greater than or equal to 10 milliohms per square @ 25.4 μm (1 mil).

TABLE 1

| | | Sheet Resisitivty | |
|---|---|---|---|
| | | (milliohms per | |
| CONVENTIONAL INKS | | square @ 1 mil) | |
| [a] | CSS-015A | 20 | Precisia LLC (Ann Arbor, MI) |
| [b] | CSS-010A | 32-35 | Precisia LLC (Ann Arbor, MI) |
| [c] | AG-755 | 23 | Conductive Compounds (Londonderry, NH) |
| [d] | PI-2500 | 11-22 | Dow Corning Corp. (Midland, MI) |
| [e] | Electrodag ® PF-007 | 20 | Acheson Colloids Co. (Port Huron, MI) |
| [f] | Electrodag ® 28RF107 | 10 | Acheson Colloids Co. (Port Huron, MI) |
| [g] | Electrodag ® SP-405 | 60 | Acheson Colloids Co. (Port Huron, MI) |
| [h] | 118-09 | 19 | Creative Materials Inc. (Tyngsboro, MA) |
| [i] | PTF-12 A/B | 20 | Advanced Conductive Materials (Atascadero, CA) |
| [j] | Silver 26-8204 | >20 | Coates Screen (St. Charles, IL) |
| [k] | 5000 | 15 | DuPont Microcircuit Materials (Research Triangle Park, NC) |
| [l] | 5029 | 10 | DuPont Microcircuit Materials (Research Triangle Park, NC) |
| [m] | 5021 | 15-17 | DuPont Microcircuit Materials (Research Triangle Park, NC) |

The inventors have shown in U.S. patent application entitled “Heat Enhancement in Critical Viewing Area of Transparent Panel” submitted on Dec. 9, 2005, the entirety of which is hereby incorporated by reference, that a “highly” conductive ink exhibiting a sheet resistivity lower than about 8 milliohms per square @ 25.4 μm (1 mil), preferably less than about 6 milliohms/square @ 25.4 μm (1 mil), can be used make a functioning defroster with grid lines in excess of 750 mm (30″). The best performance that one could expect from a printed grid is demonstrated by a printed & sintered grid line present on a defroster made for a glass window. On the other hand, unacceptable performance has been viewed as that exhibited by conventional silver pastes or inks cured under normal conditions.

Unfortunately, the number of “highly” conductive inks commercially available is extremely limited as compared to the number of conventional inks in existence (Table 1). In addition, “highly” conductive inks may also suffer from high cost, significant variation in batch to batch performance, and strict cure conditions or requirements. The present invention allows conventional silver pastes or inks to be used with acceptable performance after the printed and cured ink is exposed to a high power treatment.

The inventors have surprisingly discovered that a slight decrease in sheet resistivity occurs for a silver ink after a “cured” defroster pattern is subjected to a thermoforming step during the process of making a prototype window. In a thermoforming step a plastic sheet comprising a printed and cured defroster is exposed to a temperature above the glass transition temperature (Tg) of the plastic panel upon which it is printed in the presence of a fixture formed to the shape of the desired window. Thus, in this process the defroster is exposed to a temperature higher than its normal or conventional cure temperature. The lower sheet resistivity exhibited by the printed silver ink after thermoforming indicates that a “cured” conductive ink can undergo further curing or even possibly fusing of the silver particles upon being heated to a higher temperature.

The inventors further discovered that a significant increase in conductivity (e.g., a decrease in sheet resistivity) of a “cured” silver ink or paste could be obtained upon subjecting a printed and “cured” heater grid to a high voltage for very short time intervals (e.g., an AC electric field). The inventors believe that the high electrical power to which the defroster pattern is subjected to over short time intervals induces further curing by the resistive heating of the “cured” conductive ink. The utilization of this high power treatment concentrates the heat where it is needed within the heater grid (e.g., within the grid lines), thereby, minimizing any damage to the plastic panel.

A decrease in the sheet resistivity of the “cured” ink used to form a defroster, reduces the overall resistance of the heater grid, which allows for a higher current draw through each of the grid lines. A higher current draw ultimately results in a greater amount of resistance heating within the grid lines of the defroster.

Cured, Highly Conductive Inks

A total of seven different defroster patterns each printed on polycarbonate panels using a highly conductive ink exhibited an initial resistance ranging between 1.8 to 3.2 ohms. The highly conductive ink utilized exhibits a sheet resistivity of about 5 milliohms per square @ 25.4 μm (1 mil) after being cured at 129° C. for 1 hour. The printed and cured heater grid was then subjected to a high power treatment after establishing electrical connection to the busbar through the adhesion of an electrical connector or pin to the bus bar using a conductive adhesive or ultrasonic welding. Several of the parameters associated with this high power treatment along with a comparison of the initial resistance exhibited by each heater grid and the resulting resistance of each heater grid is provided in Table 2. The high power treatment used on all conductive heater grids (Run #'s 1-7), applied a voltage of about 100 volts to the “cured” heater grid.

TABLE 2

| | | Resistance¹ | | Maximum Line | |
|---|---|---|---|---|---|
| Run # | Sample No. | Initial | Final | Temperature² | High Power Treatment Parameters |
| 1 | 932-23204-40952 | 3.2 Ω | 1.5 Ω | 80° C. | 1000 (4 ms) pulses + |
| | | | | | 200 (40 ms) pulses |
| 2 | 932-23204-40951 | 2.2 | 1.7 | 108 | 200 (40 ms) pulses |
| 3 | 932-23204-40956 | 2.2 | 1.7 | 100 | 1100 (40 ms) pulses |
| 4 | 932-23604-40975 | 1.9 | 1.6 | 123 | 250 (40 ms) pulses |
| 5 | 932-23604-40976 | 1.9 | 1.3 | 74 | 300 (40 ms) pulses |
| 6 | 932-23604-40967 | 1.8 | 1.2 | 144 | 400 (40 ms) pulses |
| 7 | 932-23204-40955 | 2.3 | 1.7 | 125 | 400 (40 ms) pulses |

¹Measured across the heater grid pattern;
²Temperature of shortest grid line

The application of a high power treatment comprising a pulse shaped train as the wave shape form as described above results to a heater grid results in an overall decrease in resistance of the heater grid. The average observed decrease in defroster resistance was about 29% over a measured range of 16% (Run #4) to 53% (Run #1). The sheet resistivity of the “cured” conductive ink was discovered to decrease from its original value of about 5 milliohms/square @ 25.4 μm (1 mil) to about 2 milliohms/square @ 25.4 μm (1 mil) after the application of this high power treatment. A minimum in defroster resistance was obtained in less than 5 minutes with less than one minute being possible. Grid line temperatures were observed to reach as high as 144° C. (Run #6) with no significant damage to the polycarbonate. A grid line temperature of greater than about 70° C. (i.e., 74° C. in Run #5) was found to still result in a significant decrease in sheet resistivity of the “cured” conductive ink and overall resistance of the heater grid. The presence of any defects (i.e., inclusions, etc.) in the printed and cured heater grid was found to cause immediate failure of the defroster pattern. Thus, the high power treatment may also be used as a potential quality control tool for an industrialized manufacturing process.

The sheet resistivity exhibited by a conductive ink on a plastic panel of about 2 milliohms/square @ 25.4 μm (1 mil) as described above will provide a heater grid that exhibits performance equivalent to that observed for a sintered conductive fritted ink on a glass substrate. The sheet resistivity of a fritted ink used in a conventional heater grid on a glass window was measured to be approximately 2-3 milliohms/square @ 25.4 μm (1 mil).

In order for the application of a high power treatment to a conductive heater grid on a plastic panel to be beneficial, a reduction in the resistance of the heater grid on the order of about 10% or higher is desirable with greater than about 25% being especially desirable. A beneficial reduction in the resistance associated with a conductive heater grid occurs when the application of the high power treatment of the present invention to the grid reduces the sheet resistivity of the “cured” conductive ink that comprises the printed grid. A reduction in the sheet resistivity of the “cured” conductive ink on the order of about 10% or higher is preferable with greater than about 25% being especially preferred.

The high power treatment of a printed and “cured” heater grid on a plastic panel comprises the application of a high voltage for short time periods with between about 20 to about 140 volts being preferred and between about 45 and about 120 volts being especially preferred. The voltage represents the amplitude of a wave shape form applied to the heater grid during the high power treatment.

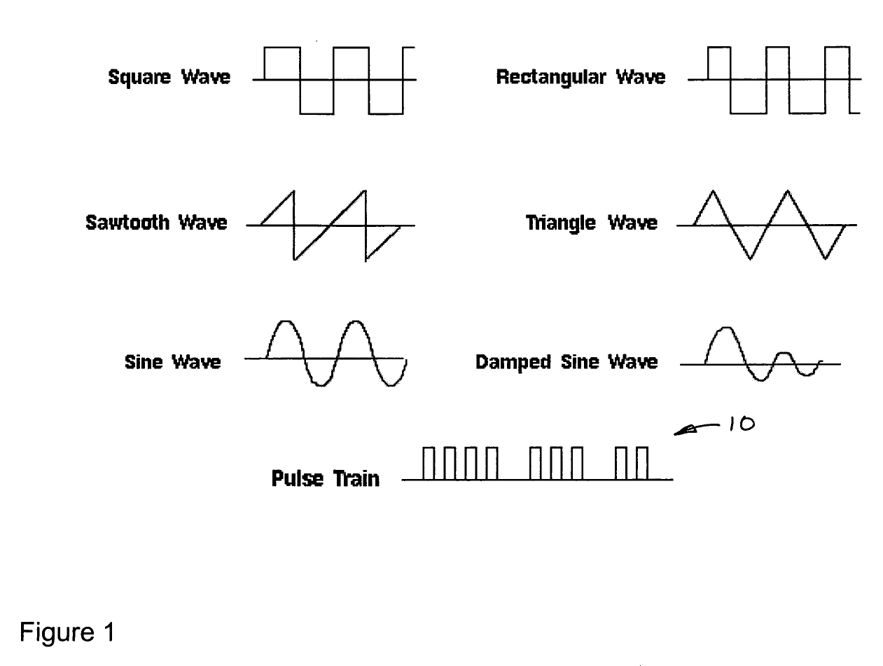

The applied wave shape form may be one of a variety of wave shapes, including a square wave, a rectangular wave, a sine wave, a damped sine wave, a sawtooth wave, a triangle wave or a pulse train 10 as shown in FIG. 1. A pulse train 10 is the preferred wave shape form for use in the high power treatment of this invention. A pulse 12 differs from a wave in that a pulse 12 is not a continuous function, but rather a single-shot or transient signal. A pulse resembles what a person would encounter if they turned a power switch on and then off again. A pulse train 10 is created by a collection of pulses 12 traveling together as demonstrated in FIG. 1.

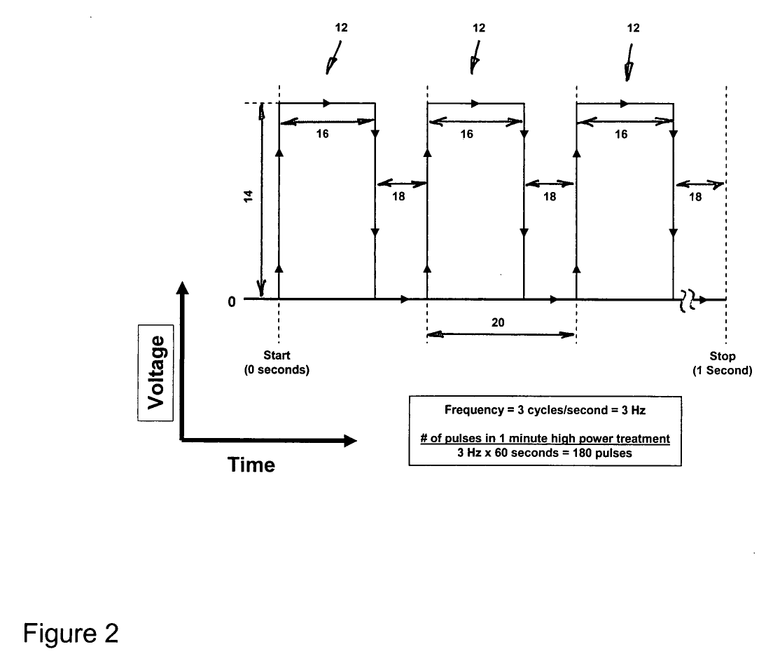

Several key parameters of the high power treatment of the present invention, such as amplitude 14, width 16, pause 18, and number of pulses 12 associated with a wave shape form are generally defined and illustrated in FIG. 2 using a pulse train 10. The width 16 of a pulse 12 in a pulse train 10 is defined as the time that the voltage is applied to the conductive heater grid. In the case of a pulse train 10, a “pause” 18 is further defined to represent the time that the voltage is turned off. The sum of the width 16 and pause 18 associated with each pulse 12 in the pulse train 10 is a period 20 similar to the period associated with a wave form. The number of pulses 12 in a pulse train 10 is defined as the product of the pulse frequency and the overall time the high power treatment is applied to the heater grid. In other words the number of pulses 12 is given by multiplying the pulse frequency by the overall time associated with the high power treatment. Pulse frequency refers to the number of pulses 12 that occur in a one second time frame. For example, if the frequency of the pulse 12 is 3 Hz and the overall time provided for the high power treatment is 1 minute (60 seconds), then the number of pulses 12 applied to the conductive heater grid would be 3 pulses/second×60 seconds or 180 pulses.

The width 16 of the pulses 12 applied to the conductive heater grid preferably ranges from about 10 milliseconds to about 100 milliseconds, with about 25 milliseconds to about 50 milliseconds being especially preferred. The frequency of the pulses 12 applied to the heater grid preferably ranges from about 1 Hz, to about 10 Hz with about 3 Hz to about 7 Hz being especially preferred. The time period over which the high power treatment is applied to the conductive and cured heater grid is preferably less than about 5 minutes (300 seconds), with less than about 1 minute (60 seconds) being especially preferred. Thus the number of pulses 12 applied to the heater grid during the high power treatment preferably ranges from about 20 pulses, to about 1500 pulses with about 50 pulses to about 200 pulses being especially preferred.

The inventors performed a ½ fractional 2⁴ factorial experimental design (DOE) in order to fully understand and optimize the interaction of four key variables, namely, voltage, pulse width, frequency, and number of pulses, in the high power treatment. In particular, these variables were evaluated with respect to their interaction with the sheet resistivity exhibited by the “cured” conductive ink used in forming the heater grid. The inventors found that both the voltage and pulse width significantly affect the sheet resistivity of a highly conductive ink.

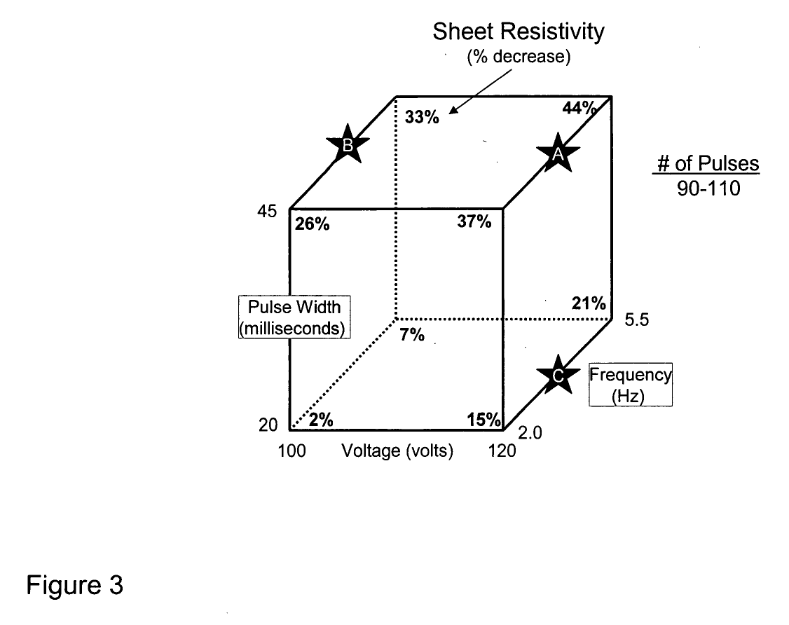

As mentioned previously, a highly conductive ink exhibits an initial sheet resistivity on the order of about 5 milliohms/square @ 25.4 μm (1 mil). The decrease in the sheet resistivity, as shown in FIG. 3, of the “cured” highly conductive ink used in the heater grid after being exposed to the high power treatment of this invention ranged from about 2% to about 44%. The greatest decrease (about 37-44%) in the sheet resistivity of the highly conductive ink occurs when the voltage and pulse width are largest as shown by star (A) in FIG. 3. Over the variable range investigated in the DOE, the largest decrease corresponds to the application of a voltage of 120 volts and a pulse width of 45 milliseconds. A decrease in the sheet resistivity of about 26-33%, star (B), and about 15-21%, star (C), occurs when the applied voltage is 100 volts and 120 volts and the pulse width is 45 milliseconds and 20 milliseconds, respectively. This DOE demonstrates that a voltage of about 120 volts or less and a pulse width of about 50 milliseconds or less is preferred. The number of pulses, as determined by taking the product of the pulse frequency and the amount of time the high power treatment is applied, has been found to have only a minor affect on reducing the sheet resistivity exhibited by a “cured” highly conductive ink. When the initial sheet resistivity of the “cured” ink is about 5 milliohms/square @ 25.4 μm (1 mil), the resulting sheet resistivity after the application of a high power treatment will be about 2.8 milliohms/square @ 25.4 μm (1 mil). After the application of a high power treatment, the sheet resistivity of the “cured” highly conductive ink in the heater grid on a plastic panel is approximately equivalent to the sheet resistivity exhibited by a sintered ink on a glass window.

Cured, Conventional Conductive Inks

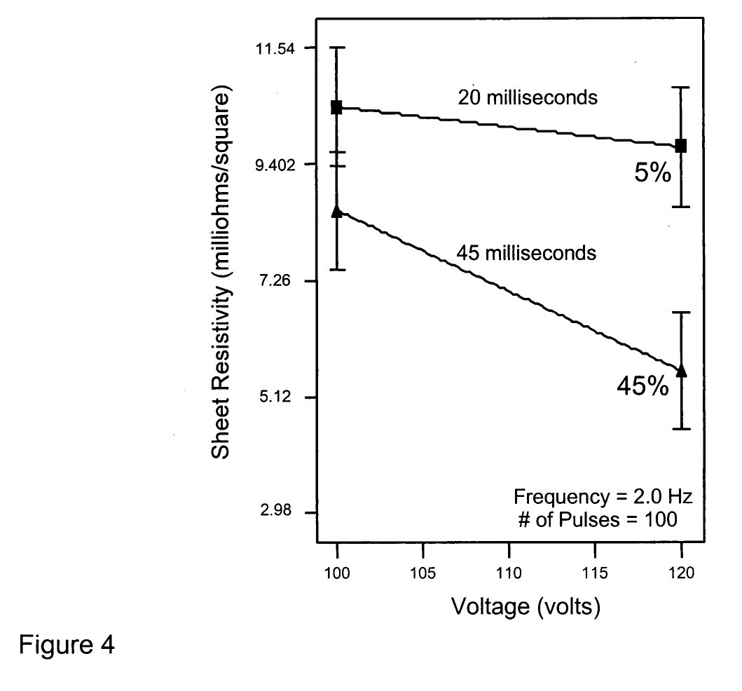

A similar reduction in sheet resistivity occurs when a conductive heater grid utilizing a conventional, “cured” conductive ink is subjected to the high power treatment of the present invention. As previously noted, a “cured” conventional conductive ink exhibits an initial sheet resistivity of about 10 milliohms/square @ 25.4 μm (1 mil). In this case, the variables in the high power treatment that have the greatest affect on the sheet resistivity of the “cured” ink are again voltage and pulse width, as shown in FIG. 4. Upon the use of higher voltage (i.e., 100→120 volts) and higher pulse width (i.e., 20→45 milliseconds) in the high power treatment, a decrease in the sheet resistivity exhibited by the “cured” conventional ink of about 45% occurs. When the initial sheet resistivity of the “cured” conventional ink is about 10 milliohms/square @ 25.4 μm (1 mil), the resulting sheet resistivity after the application of a high power treatment decreases to about 5.5 milliohms/square @ 25.4 μm (1 mil). This example demonstrates that a conventional conductive ink can be used to form a conductive heater grid on a plastic substrate, provided a subsequent high power treatment is applied to the “cured” heater grid. Upon exposure to the high power treatment, the sheet resistivity of the “cured” conventional ink is reduced to about the level of a “cured” highly conductivity ink as previously described. Highly conductive inks are further defined in U.S. patent application entitled “Heat Enhancement in Critical Viewing Area of Transparent Panel” submitted on Dec. 9, 2005. However, the use of a highly conductive ink to form the heater grid is preferred over the use of a conventional conductive ink because, after the use of the high power treatment of the present invention, the resulting sheet resistivity exhibited by the “cured” highly conductive ink is similar to a fritted conductive ink commonly used in the preparation of conventional glass window defrosters.

### EXAMPLES

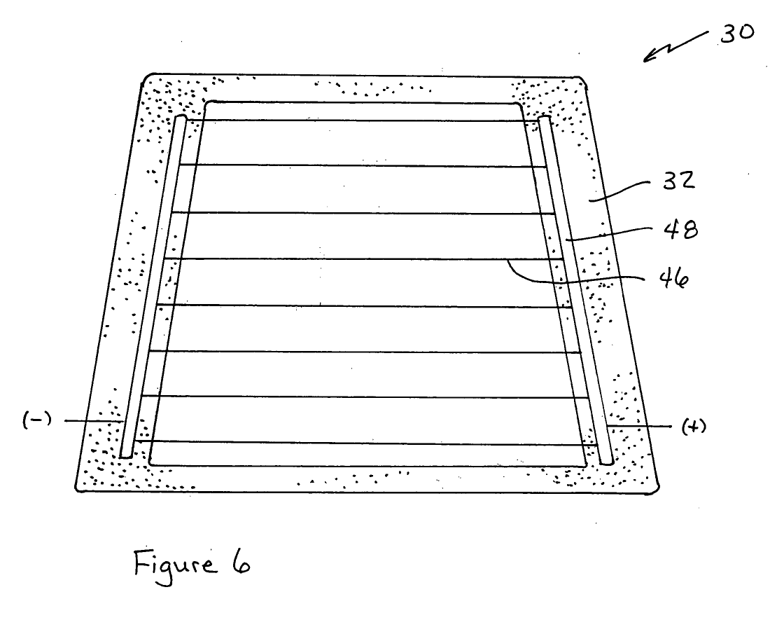

Three different conductive inks (two highly conductive and one conventional conductive) applied to a plastic panel, on top of protective layers providing the panel with weatherability and abrasion resistance, in the form of a heater grid 36 having a plurality of grid lines 46 extending between two busbars 48 and subsequently cured at 129° C. for 1 hour. An illustrative example of a heater grid formed on a panel is seen in FIG. 6. The initial sheet resistivity exhibited by the “cured” conductive inks ranged between 6-10 milliohms/square @ 25.4 μm (1 mil) as shown in Table 3. Each of the panels were subjected to the high power treatment of the present invention. The various parameters used in conjunction with the high power treatment applied to each of the printed and cured heater grids is also provided in Table 3, along with a measurement of the resulting sheet resistivity of the “cured” conductive ink after the application of the high power treatment. A decrease in sheet resistivity of about 29% (Run #9) to 40% (Run #10) was found to occur. Run #'s 8-10 further demonstrate that a high power treatment comprising voltage of about 45 volts, a pulse width of about 32 milliseconds at a frequency of about 3 Hz results in a substantial descrease in the sheet resistivity of a “cured” conductive ink used to form the conductive heater grid.

TABLE 3

| | | Sheet | | | | |
|---|---|---|---|---|---|---|
| | | Resistivity | | | | |
| | Initial | after High | | | | |
| | Sheet | Power | High Power Treatment Parameters | | | |
| | Resistivity | Treatment | | Pulse | Pulse | |
| | (milliohms | (milliohms | Voltage | Width | Frequency | # of |
| Run # | per square) | per square) | (volts) | (milliseconds) | (Hz) | Pulses |
| 8 | 6 | 4 | 53 | 32 | 3 | 100 |
| 9 | 7 | 5 | 48 | 45 | 6 | 110 |
| 10 | 10 | 6 | 60 | 45 | 6 | 110 |

The window assembly 30 includes a transparent plastic panel 32 may be constructed of any thermoplastic polymeric resin or a mixture or combination thereof. The thermoplastic resins of the present invention include, but are not limited, to polycarbonate resins, acrylic resins, polyarylate resins, polyester resins, and polysulfone resins, as well as copolymers and mixtures thereof. Transparent panels 32 may be formed into a window through the use of any known technique to those skilled in the art, such as molding, thermoforming, or extrusion. The panels 32 may further include areas of opacity, such as a black-out border and logos 34, applied by printing an opaque ink or molding a border using an opaque resin.

A heater grid 36 may be integrally printed directly onto the surface of the plastic panel or on the surface of a protective layer 38 using a conductive ink or paste and any method known to those skilled in the art including, but not limited to, screen-printing, ink jet, or automatic dispensing. Automatic dispensing includes techniques known to those skilled in the art of adhesive application, such as drip & drag, streaming, and simple flow dispensing.

The plastic panel 32 may be protected from such natural occurrences as exposure to ultraviolet radiation, oxidation, and abrasion through the use of a single protective layer 38 or additional, optional protective layers 40. Thus, a multi-layer protective coating system may comprise the protective layer 38, 40. As used herein, the transparent plastic panel 32 with at least one protective layer is defined as a transparent plastic glazing panel. The protective layer 38, 40 may consist of a plastic film, an organic coating, an inorganic coating, as well as a plurality or mixture thereof. The plastic film may be of the same or different composition as the transparent panel 32. The film and coatings may comprise ultraviolet absorber (UVA) molecules, rheology control additives, such as dispersants, surfactants, and transparent fillers (e.g., silica, aluminum oxide, etc.) to enhance abrasion resistance, as well as other additives to modify optical, chemical, or physical properties.

Examples of organic coatings include but are not limited to polymethylmethacrylate, polyvinylidene fluoride, polyvinylfluoride, polypropylene, polyethylene, polyurethane, silicone, polymethacrylate, polyacrylate, polyvinylidene fluoride, silicone hardcoat, and mixtures or copolymers thereof. Some examples of inorganic coatings include aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, hydrogenated silicono oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, or a mixture or blend thereof.

The coatings may be applied by any suitable technique known to those skilled in the art. These techniques include deposition from reactive species, such as those employed in vacuum-assisted deposition processes, and atmospheric coating processes, such as those used to apply organic or sol-gel coatings to substrates. Examples of vacuum-assisted deposition processes include but are not limited to plasma-enhanced chemical vapor deposition (PECVD), expanding thermal plasma PECVD, plasma polymerization, photochemical vapor deposition, ion beam deposition, ion plating deposition, cathodic arc deposition, sputtering, evaporation, hollow-cathode activated deposition, magnetron activated deposition, activated reactive evaporation, and thermal chemical vapor deposition. Examples of atmospheric coating processes include but are not limited to curtain coating, spray coating, spin coating, dip coating, and flow coating.

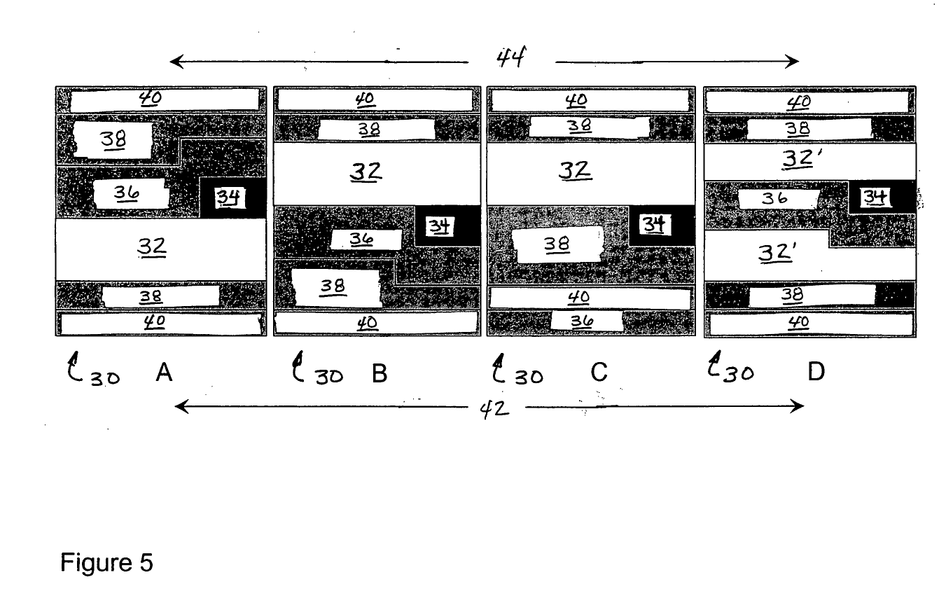

A heater grid 36 may be placed near the internal side or surface 42 or external side surface 44 of a window by application of the grid pattern onto the plastic panel 32, onto the outermost protective layer 38, 40, or between two protective layers. One construction of the present invention includes a heater grid 36 printed onto the surface of the plastic panel 32 and beneath any and all protective layers 38, 40 on the exterior side 44 or interior side 42 of the panel 32 (FIGS. 5A and 5B, respectively), while another construction includes a heater grid 36 printed onto the surface of the outermost protective layer 40 (FIG. 5C). For example, a polycarbonate panel comprising the Exatec® 900 automotive window glazing system with a printed defroster corresponds to the embodiment of the present invention generally described in FIG. 5C. In this particular construction, the transparent polycarbonate window is protected with a multilayer coating system (acrylic coating—Exatec® SHP-9X, silicone coating—Exatec® SHX, and a glass-like coating—SiOₓC_{y}H_{z}) that is then printed with a heater grid on the surface of the outermost protective layer 40 facing the interior 42 of the vehicle. In an alternative construction, the heater grid 36 is placed on top of a layer or layers of a protective coating or coatings, then subsequently over-coated with an additional layer or layers of a protective coating or coatings. For instance, a conductive heater grid may be placed on top of a silicone protective coating (e.g., AS4000, GE Silicones) and subsequently over-coated with a “glass-like” film.

Another embodiment of the present invention integrally places the heater grid 36 within the plastic panel 32′ (FIG. 5D). These embodiments may involve the initial application of the heater grid 36 to a thin film or panel of transparent plastic. The transparent film or panel may be subsequently thermoformed to the shape of the window and placed into a mold and exposed to a plastic melt via injection molding to form the plastic panel or window. The thin film and a transparent panel or two transparent panels become laminated or adhesively adhered together. The plastic panel or film upon which the heater grid 36 is placed may also contain a decorative ink pattern 34 (e.g., black-out, etc.), as well as other added functionality.

The conductive pastes or inks of the present invention may be comprised of conductive particles (e.g., flakes or powders) dispersed in a carrier medium. The conductive inks may further comprise a polymeric binder, including but not limited to, an epoxy resin, a polyester resin, a polyvinyl acetate resin, a polyvinylchloride resin, a polyurethane resin or mixtures and copolymers of the like. Various other additives, such as dispersants, thixotropes, biocides, antioxidants, metallic salts, metallic compounds, and metallo-decomposition products to name a few, may be present in the conductive inks. Some examples of metallic salts and metallic compounds include tertiary fatty acid silver salts, metallic carbonate, and metallic acetate compounds. Some examples of metallo-organic decomposition products include carboxylic acid metallic soaps, silver neodecanoate, and gold amine 2-ethylhexanoate.

The conductive particles present in the conductive paste or ink of the present invention may be comprised of a metal, including but not limited to silver, silver oxide, copper, zinc, aluminum, magnesium, nickel, tin, or mixtures and alloys of the like, as well as any metallic compound, such as a metallic dichalcogenide. These conductive particles, flakes, or powders may also comprise some conductive organic materials known to those skilled in the art, such as polyaniline, amorphous carbon, and carbon-graphite. Although the particle size of any particles, flakes, or powders may vary, a diameter of less than about 40 μm is preferred with a diameter of less than about 1 μm being specifically preferred. A mixture of particle types and sizes may be utilized to enhance conductivity and lower sheet resistivity by optimizing particle packing. Any solvents, which act as the carrier medium in the conductive pastes or inks, may be a mixture of any organic vehicle or solvent that provides solubility or dispersion stability for the organic resin, additives, or conductive particles.

While the present invention has been described in terms of preferred embodiments, it will be understood, of course, that the invention is not limited thereto since modifications may be made to those skilled in the art, particularly in light of the foregoing teachings.

What is claimed is:

1. A method for forming a plastic window assembly, the method comprising:
forming a transparent plastic panel;
applying at least one protective layer to the panel;
providing a conductive ink onto one of the panel and the protective layer in the form of a heater grid having a plurality of grid lines connected between at least two busbars;
curing the conductive ink of the printed heater grid;
establishing electrical connection to each busbar of the heater grid; and
reducing the resistance of the heater grid after curing of the conductive ink.

2. The method of claim 1 wherein the printing of the conductive ink onto the protective layer is performed using one of the methods selected from screen-printing, ink jet, and automatic dispensing.

3. The method of claim 1 wherein the curing of the conductive ink is performed using one of the methods selected from exposure to thermal heat, exposure to UV radiation, and catalytic cross-linking of polymeric resins present in the ink.

4. The method of claim 1 wherein the protective layer is applied to the plastic panel using one of the methods selected from plasma-enhanced chemical vapor deposition (PECVD), expanding thermal plasma PECVD, plasma polymerization, photochemical vapor deposition, ion beam deposition, ion plating deposition, cathodic arc deposition, sputtering, evaporation, hollow-cathode activated deposition, magnetron activated deposition, activated reactive evaporation, and thermal chemical vapor deposition.

5. The method of claim 1 wherein the protective layer is applied to the plastic panel using one of the methods selected from curtain coating, spray coating, spin coating, dip coating, and flow coating.

6. The method of claim 1 wherein the reducing step includes subjecting the heater grid to a high power treatment.

7. The method of claim 6 wherein the high power treatment includes applying to the heater grid a wave shape form having a predetermined amplitude, pulse width, pulse frequency, time duration, and number of applied pulses.

8. The method of claim 7 wherein the wave shape form is one selected from the group of a square wave, a rectangular wave, a triangular wave, a sine wave, a damped sine wave, a pulse train, or a combination or mixture thereof.

9. The method of claim 8 wherein the amplitude of the wave shape form is defined as the voltage applied to the conductive heater grid.

10. The method of claim 9 wherein the voltage applied to the conductive heater grid is between about 20 volts and about 140 volts.

11. The method of claim 8 wherein the voltage applied to the conductive heater grid is between about 45 to 120 volts.

12. The method of claim 7 wherein the pulse width is between about 10 milliseconds and about 100 milliseconds.

13. The method of claim 7 wherein the pulse width is between 25 milliseconds and about 50 milliseconds.

14. The method of claim 7 wherein the pulse frequency is between about 1 Hz and about 10 Hz.

15. The method of claim 7 wherein the pulse frequency is between about 3 Hz and about 7 Hz.

16. The method of claim 7 wherein the time duration is less than 5 minutes.

17. The method of claim 7 wherein the time duration is less than 1 minute.

18. The method of claim 7 wherein the number of applied pulses is between about 20 and about 1500.

19. The method of claim 7 wherein the number of applied pulses is between about 50 and about 200.

20. The plastic window assembly of claim 1 wherein the resistance of the conductive heater grid is reduced by greater than about 10%.

21. The plastic window assembly of claim 1 wherein the resistance of the conductive heater grid is reduced by greater than about 25%.

22. The method of claim 1 wherein the forming step includes forming the plastic panel into a desired shape performed using one of the methods selected from injection molding, thermoforming, or lamination.

23. The method of claim 1 wherein the providing step includes printing the heater grid onto a plastic protective layer, and placing the plastic protective layer into the cavity of a mold.

24. The method of claim 23 wherein the forming step includes injecting a plastic resin into the mold having the protective layer therein to form the plastic panel.

25. A plastic window assembly providing defrost and defog capabilities through the resistive heating of a cured conductive ink comprising:
a transparent plastic panel;
at least one protective layer over the plastic panel;
a conductive heater grid having a plurality of primary grid lines with opposing ends of each grid line being connected to a first and second busbar the heater grid being formed of a printed and cured conductive ink; and
at least one electrical connection to the first and second busbar thereby establishing a closed electrical circuit;
wherein the heater grid has been treated by a high power treatment reducing the resistance of the heater grid from the resistances of the heater grid absent the high power treatment.

26. The plastic window assembly of claim 25 wherein the conductive ink comprises conductive particles dispersed in a carrier medium.

27. The plastic window assembly of claim 26 wherein the conductive particles comprise one selected from metal flakes, metal powders, or mixtures thereof.

28. The plastic window assembly of claim 27 wherein the metal flakes and metal powders comprise one selected from silver, silver oxide, copper, zinc, aluminum, magnesium, nickel, tin, or mixtures and alloys of the like.

29. The plastic window assembly of claim 26 wherein the conductive particles have a diameter less than about 40 μm.

30. The plastic window assembly of claim 26 wherein the conductive ink further comprises a polymeric binder.

31. The plastic window assembly of claim 30 wherein the polymeric binder comprises one selected from epoxy resin, a polyester resin, a polyvinyl acetate resin, a polyvinylchloride resin, a polyurethane resin, or a copolymer or blend thereof.

32. The plastic window assembly of claim 26 wherein the carrier medium comprises a mixture of organic solvents that provide solubility for the polymeric binder and dispersion stability for the conductive particles.

33. The plastic window assembly of claim 26 wherein the conductive ink further comprises an additive selected from metallic salts, metallic compounds, metallo-decomposition products, or mixture or blend thereof.

34. The plastic window assembly of claim 33 wherein the metallic salts are tertiary fatty acid silver salts.

35. The plastic window assembly of claim 33 wherein the metallic compounds comprise one selected from metallic carbonate, metallic acetate compounds, or mixtures or blends thereof.

36. The plastic window assembly of claim 33 wherein the metallo-organic decomposition products comprise one selected from carboxylic acid metallic soaps, silver neodecanoate, gold amine 2-ethylhexanoate, or mixtures or blends thereof.

37. The plastic window assembly of claim 25 wherein the conductive heater grid is printed directly onto a surface of the transparent plastic panel.

38. The plastic window assembly of claim 25 wherein the conductive heater grid is printed directly onto a surface of a protective layer.

39. The plastic window assembly of claim 25 wherein the conductive ink is cured by exposure to thermal heat, exposure to UV radiation, or by catalytic cross-linking of polymeric resins present in the ink.

40. The plastic window assembly of claim 25 wherein the high power treatment comprises applying a wave shape form to the conductive heater grid having a predetermined amplitude, pulse width, pulse frequency, time duration, and number of applied pulses.

41. The plastic window assembly of claim 40 wherein the wave shape form is one selected from the group of a square wave, a rectangular wave, a triangular wave, a sine wave, a damped sine wave, a pulse train, and combinations thereof.

42. The plastic window assembly of claim 25 wherein the resistance of the conductive heater grid is reduced by greater than about 10% as compared to the resistance of the heater grid absent the high power treatment.

43. The plastic window assembly of claim 25 wherein the resistance of the conductive heater grid is reduced by greater than about 25% as compared to the resistance of the heater grid absent the high power treatment.

44. The plastic window assembly of claim 25 wherein the high power treatment raises the maximum temperature of the shortest grid line to greater than about 70° C.

45. The plastic window assembly of claim 25 wherein the high power treatment further reduces an initial sheet resistivity of the cured conductive ink by greater than about 10%.

46. The plastic window assembly of claim 45 wherein the initial sheet resistivity of the cured conductive ink is reduced by greater than about 25%.

47. The plastic window assembly of claim 25 wherein an initial sheet resistivity of the cured conductive ink is greater than about 5 milliohms/square @ 25.4 μm (1 mil).

48. The plastic window assembly of claim 25 wherein an initial sheet resistivity of the cured conductive ink is greater than about 10 milliohms/square @ 25.4 mm (1 mil).

49. The plastic window assembly of claim 25 wherein the sheet resistivity of the cured and treated conductive ink is less than about 6 milliohms/square @ 25.4 mm (1 mil).

50. The plastic window assembly of claim 47 wherein the cured conductive ink is a highly conductive ink.

51. The plastic window assembly of claim 48 wherein the cured conductive ink is a conventional conductive ink.
